(19) United States
(12) Patent Application Publication
(10) Pub. No.: US 2026/0181407 A1
(43) Pub. Date: Jun. 25, 2026

(54) ENVIRONMENT-AWARE BEAMSWEEPING

(71) Applicant: T-Mobile USA, Inc., Bellevue, WA (US)

(72) Inventor: Al Duy Bui, Seattle, WA (US)

(21) Appl. No.: 18/990,913

(22) Filed: Dec. 20, 2024

(51) Int. Cl. H04W 16/28; H04L 41/085

(52) U.S. Cl. CPC H04W 16/28; H04L 41/085

(57) ABSTRACT

Beamsweeping and beam refinement can be used for high performance wireless telecommunications networks. However, beamsweeping processes can have significant drawbacks, such as wasted power and long attachment times. The approaches described herein enable environment-aware beamsweeping. Using environment-aware beamsweeping, a base station can perform beamsweeping operations in manners that conserve power, decrease attachment times, or both. In some implementations, a beamsweeping configuration algorithm is used to preferentially sweep in areas where user equipment is more likely to be found. This can reduce or eliminate power, time, or both, spent sweeping areas that see few or no attachments, for example because of environmental obstacles that prevent user equipment from attaching in certain areas.

### BACKGROUND

Beamsweeping is an important technique for wireless telecommunications networks. However, current approaches have certain limitations. Accordingly, there is a need for improved beamsweeping techniques.

### BRIEF DESCRIPTION OF THE DRAWINGS

Detailed descriptions of implementations of the present invention will be described and explained through the use of the accompanying drawings.

FIG. 1 is a block diagram that illustrates a wireless telecommunication network in which aspects of the disclosed technology are incorporated.

FIG. 2 is a block diagram that illustrates an architecture including 5G core network functions (NFs) that can implement aspects of the present technology.

FIG. 3A is a drawing that schematically illustrates an attachment and beam refinement process according to some implementations.

FIG. 3B is a flowchart that illustrates an attachment and refinement process according to some implementations.

FIG. 4 is a flowchart that illustrates an example beamsweeping optimization process according to some implementations.

FIG. 5A is a table that illustrates an example historically-aware beamsweeping configuration according to some implementations.

FIG. 5B is a table that illustrates an example historically-aware beamsweeping configuration according to some implementations.

FIG. 6 is a drawing that schematically illustrates possible beamsweeping configurations according to some implementations.

FIG. 7 illustrates a machine learning process according to some embodiments.

FIG. 8 is a flowchart of an example method for historically-aware beamsweeping according to some implementations.

FIG. 9 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Beamsweeping is a technique in which a base station (e.g., a gNodeB in a 5G network) transmits signals in different directions to scan an area to find the best direction for communication. This allows the base station to focus the signal toward a specific user device (e.g., a smartphone or other user equipment), which can improve signal strength, improve throughput, reduce interference, and so forth. The base station can sweep through a range of angles, and the user device can measure the received signal strength (RSS) or reference signal received power (RSRP) and transmit this information back to the base station. The beam associated with the highest RSS or RSRP can be selected for communication. Typically, beamsweeping involves sweeping over ranges of angles. For example, a geographic area can be divided into multiple angular ranges, and a base station can transmit signals in the different angular ranges. Such angular ranges are referred to as “zones” herein. Zones can overlap. That is, if there are four zones, for example, a user device that is best served by beam two which is directed into zone two may nonetheless receive a beam one signal (directed to zone one) and beam three (directed into zone three), though such signals may be of poorer quality.

As described in more detail herein, beamsweeping can be a multi-step process. For example, a relatively large zone can be divided into smaller zones. A connection between a smartphone or other user equipment and a base station can be achieved and optimized by, for example, first determining a best large zone, then refining to select a smaller zone within the large zone. The same beams or different beams can be used for initial zone determination and refinement. In some cases, user equipment such as smartphones also include beamsweeping or other beam refinement capabilities. Thus, a process can include, for example, coarse beam selection at the base station and refinement at both the base station and the user equipment.

While beamsweeping is important, there are several challenges associated with beamsweeping. For example, beamsweeping involves the transmission of multiple beams to identify an optimal beam direction. This can introduce significant overhead and latency, particularly in environments where users, obstacles, and so forth are often in motion. Beamsweeping can also be associated with significant power consumption. Beamsweeping can lead to interference between different devices if their beams overlap, which can degrade performance and reduce throughput. Additionally, the initial access/attachment process can be more complex and time consuming, as devices need to identify a beam for communication. This can be especially challenging in situations involving high device density, significant motion, and so forth.

One challenge associated with beamsweeping is that it can take considerable time for a device to attach to a base station. For example, if there are four adjacent zones 1-4 and a device is in zone one but the base station is sweeping through zones two, three, and four, the device may not attach until a full sweep cycle has completed and the sweep returns to zone one. Not only does this delay device attachment, it can result in additional power usage by the device as it searches for a signal to attach to. Moreover, if there are no devices trying to attach in zones two through four, the time and power spent by the base station sweeping those zones is wasted.

A naïve beamsweeping configuration simply sweeps each zone for the same amount of time without regard to whether or not devices are likely to be present in any given zone. This results in slower attachment times, wasted power, or both. As described herein, beamsweeping can be improved by considering environmental factors and historical attachments. For example, rather than sweeping out over a very wide range without consideration for where devices are likely to be located, beamsweeping can be focused on areas where devices are likely to be present. This can reduce attachment time, conserve power, and so forth, depending upon the particular implementation. The approaches herein can be applied to any network that utilizes beamsweeping including, for example, 4G networks, 5G networks, 6G networks, or any other network.

Synchronization signal block (SSB) beams and channel state information—reference signal (CSI-RS) beams can play a significant role in the attachment process for 5G networks. During initial cell search, SSB beams are transmitted by the base station (e.g., gNB) in specific beam directions. The SSB beams can carry synchronization signals to help a user equipment (UE) detect and synchronize to the network. The UE can measure the RSS or RSRP of the SSB beams and select the beam with the highest RSS or RSRP. In a subsequent operation, the UE can send CSI-RS reports to the base station. These reports can provide channel quality information, such as channel gain information, for each beam. The base station can use the CSI-RS reports to refine the beamforming configuration and improve signal transmission. In some cases, the base station can dynamically adjust beamforming based on CSI-RS feedback.

One challenge associated with beamsweeping is that not all zones may be utilized the same amount. In some cases, certain zones may be rarely or never used. For example, obstacles in the environment can mean that certain zones are rarely or never used. User devices may rarely or never be in zones that are, for example, directed at manmade objects such as walls or natural objects such as cliffs or bodies of water.

Beamsweeping can be dividing into multiple steps or procedures. For example, beamsweeping can be dividing into a first procedure P-1, second procedure P-2, and third procedure P-3. P-1 can focus on initial acquisition for a UE in idle mode. The P-1 procedure can focus on initial acquisition based on synchronization signal block (SSB) beams. During initial acquisition, beamsweeping can take place for both transmission and reception to select the best beam pair based on RSRP measurements. In general, the beams used during the P-1 procedure are relatively wide and thus may not be optimal for wireless communications.

In procedure P-2, the procedure can focus on transmission refinement. The receive beam can remain fixed and the transmit beam can be transmitted in finer directions (e.g., over narrow angles) within the zone of the SSB beam selected in P-1. The UE can measure properties of the beams (e.g., CSI-RS for transmit-end downlink beam refinement, SRS for transmit-end uplink beam refinement), which can be used to select the best transmit beam based on RSRP measurements of the transmit beams. During the P-2 procedure, the receive beam can remain fixed.

Procedure P-3 can involve receive-end beam refinement, in which refinement is performed by the UE while for a fixed transmit beam. Reference signals can be sent with the same transmit beam, and the best receive beam can be selected based on RSRP measurements of receive beams.

The approaches described herein can be applied during the P-1 procedure, the P-2 procedure, or both. While the specific beamsweeping procedures above are described in the context of 5G networks, it will be appreciated that the techniques herein can be applied generally to any wireless telecommunications network that utilizes beamsweeping.

In some implementations, an algorithm can be used to optimize beamsweeping. The beamsweeping configuration algorithm can be a predefined algorithm and/or can utilize one or more machine learning models to optimize beamsweeping. For example, an algorithm can be constructed by analyzing historical attachment data to determine optimizing beamsweeping patterns for different base stations. However, such an approach can have significant drawbacks, as attachments can vary significantly for different base stations. For example, a base station where one zone is blocked by an obstruction has no bearing on another base station without such an obstruction in that zone, and the locations of devices in relation to one base station may have nothing to do with the locations of devices in relation to another base station. However, in some implementations, a general set of rules is provided that can be applied at any base station such that the base station can dynamically or automatically adjust its beamsweeping pattern(s) in response to observed attachment behavior at the base station. In some implementations, a beamsweeping configuration algorithm is configured to optimize a single parameter, such as to minimize attachment time or power expended for attachment. In some implementations, multiple parameters are optimized. For example, a wireless telecommunications provider may seek to reduce power usage while limiting how long it takes for a UE to attach to a base station.

In some implementations, a beamsweeping configuration algorithm includes various parameters, such as weights for each zone, conditions for assigning particular weights, and so forth. In some implementations, a machine learning algorithm is trained to optimize such parameters.

Environment-aware beamsweeping can have several advantages. For example, by not sweeping or sweeping less frequently in certain zones, more time can be spent sweeping zones where devices are more likely to be present, which can decrease attachment times, thereby improving user experience. In some cases, rather than or in addition to improving attachment times, environment-aware beamsweeping can reduce power consumption by a base station. For example, a base station may simply not broadcast during certain times when it would ordinarily be sweeping a zone that less commonly has UEs in it. For example, if an area is divided into zones 1-4 and devices are rarely present in zone 4, the base station may simply not broadcast in zone 4 or may broadcast less frequently. For example, if zone 4 is to be scanned half as often as zones 1-3, a scan pattern can look like: {Zone 1; Zone 2; Zone 3; Zone 4; Zone 1; Zone 2; Zone 3; Power Off}, and the pattern can repeat. As another example, a scan pattern can look like: {Zone 1; Zone 2; Zone 3; {Zone 4; Power Off}} and the pattern can repeat, where {Zone 4; Power Off} indicates that the base station transmits in Zone 4 for half is long as in Zone 1, Zone 2, or Zone 3, and does not transmit during the other half of the time. Power can be saved during the “Power Off” period. Alternatively, time that would be dedicated to sweeping in zone 4 can be distributed across the other zones, for example based on historical attachments in those zones, enabling faster attachment.

One approach to environment-aware beamsweeping is to utilize historical attachment data to determine which zones experience relatively few attachments, and then to set beamsweeping patterns based on the historical attachment data. While this can be effective, such an approach can involve analyzing each base station independently and setting beamsweeping parameters in a static manner. Such an approach may not only be laborious and time-consuming, but can result in poor performance over time, with users experiencing slower attachments and/or other adverse effects arising from poor beamsweeping patterns. The environment can change over time, for example as buildings or other structures and/or obstacles are built or removed, as new roads are created, and so forth. In some cases, user behaviors may change over time. For example, users may rarely be boating in a lake in winter, but the lake may be a popular summer destination. If static beamsweeping is used, beamsweeping patterns can be inadequate or poorly calibrated to actual demands. Continuing with the lake example, if historical data is collected from winter months, boaters may experience slow attachment speeds or even failed attachments in the summer while on the lake. If historical data is collected from summer months, a base station may needlessly expend time and/or power beaming toward the lake when it is unlikely that there will be users on the lake. If historical data is collected over both winter and summer months, the resulting beamsweeping pattern may be sub-optimal for both winter and summer months (e.g., too much sweeping over the lake in winter months and not enough in summer months).

In some implementations, the approaches described herein can enable adaptive, environment-aware beamsweeping. Beamsweeping patterns can evolve over time to adapt to changes in where UEs are likely to be located. In some implementations, the rate of change in beamsweeping patterns can be regulated, for example to prevent large changes in beamsweeping patterns based on few attachments or to enable responsive beamsweeping changes that can quickly adapt to changes in UE locations. In some implementations, a machine learning model is used to determine rules for changing beamsweeping patterns, which can help to optimize beamsweeping patterns to achieve better attachment times, increased power savings, or both.

In some implementations, beamsweeping patterns can be defined at least in part based by classifying zones into weight groups based on past attachments. Movement rules (also referred to as move count rules) can define conditions for moving from one weight group to another weight group. Each weight group can be associated with a relative weight or weighting formula which can be based, for example, on the number zones within a particular weighting group, the number of zones in other weighting groups, and so forth. In some implementations, a criterion for moving a zone from one weighting group to another is based on which zones have recently been used for attachments.

As an illustrative example, consider three weighting groups, in which the first weighting group is associated with fewer recent attachments and the third weighting group is associated with the most attachment activity. A rule for the second weighting group can be “two attachments to move up, one attachment to move down.” Continuing with the example, if zone four is currently in the second weighting group and the next two attachments are also in zone four, then zone four can be moved from the second weighting group to the third weighting group (causing relatively greater time to be spent by the base station sweeping in zone four). On the other hand, if either the next attachment or the attachment after the next attachment is not in zone four, then zone four can be moved from the second weighting group to the first weighting group.

Within each weighting group, each zone in the group can experience the same amount of beamsweeping. For example, if there are four zones and each zone is in the first group, each zone can be allocated 25% of beamsweeping time. Different weighting groups can be allocated different proportions of beamsweeping time. Consider a two weighting group example with four zones. If there are three zones in weighting group one and one zone in weighting group two, the three zones in weighting group one can have the same weight (e.g., the same relative proportion of beamsweeping time) while the zone in weighting group two can have a relatively higher proportion of beamsweeping time. For example, if zones one through three are in weighting group one and zone four is in weighting group two, beamsweeping time can be allocated as [22%, 22%, 22%, 34%]. This is only an example, and the actual values can differ. If the rules and attachments are such that zone two moves into weighting group two, the weights can change, for example, the time allocation can be [15%, 35%, 15%, 35%].

In some implementations, move count rules are purely based on counting previous attachments. In some implementations, move count rules can include a time component and/or the relative allotment to different weighting groups can include a time component. As an example, a rule can be “two attachments in last thirty minutes to move up, two attachments in other zones in last hour to move down.” This can make weighting group assignments “stickier” such that zones do not move around based on infrequent attachments or attachments long in the past, which may not be reflective of current attachment behavior.

In some implementations, various constraints can be applied to limit the relative allotments of beamsweeping time. For example, there can be a minimum allowed beamsweeping time allotment, a maximum allowed beamsweeping time allotment, or both. In some implementations, different weighting groups are assigned maximum and/or minimum total allotment times. These values can depend on, for example, the number of zones included within a particular weighting group (e.g., an absolute number of zones or a relative proportion of zones). For example, consider a three weighting group arrangement and four total zones. A limitation could be, for example, that weighting group three (the group that includes zones used most frequently for attachment) can only have a first percentage allotment of beamsweeping time (e.g., 40%) if there is one zone in weighting group three and a second percentage allotment of time (e.g., 60%) if there are two zones in weighting group three.

It will be appreciated that, in general, there are many parameters that can be tuned to optimize beamsweeping and the attachment process, including, for example and without limitation, move count rules, zone weights, minimum weight thresholds, maximum weight thresholds, and so forth. In some implementations, the number of weighting zones can be tuned.

In some implementations, additionally or alternatively, beamsweeping pattern adjustments can be used to conserve power by limiting transmission into certain zones. For example, zones with less frequent attachments can be swept less frequently than other zones with more frequent attachments. Consider an example in which zone one is to be swept 50% of the time it would be swept without environment-aware beamsweeping, zone two is to be sweep 75% of the time it would be without environment-aware beamsweeping, and zones three and four are to be swept 100% of the time they would be swept without environment aware beamsweeping. In some implementations, a beamsweeping pattern can still sweep through each zone in sequence but may only transmit within certain zones for a limited amount of time. Continuing with the above example, a sweep pattern that sweeps each zone on every iteration can look like (where a value of 1 for “Power On” indicates transmission and a value of 0 indicates no transmission):

| Zone | 1 | | | | 2 | | | | 3 | | | | 4 | | | |
|---|---|---|---|---|---|---|---|---|---|---|---|---|---|---|---|---|
| Time Slot | 1 | 2 | 3 | 4 | 5 | 6 | 7 | 8 | 9 | 10 | 11 | 12 | 13 | 14 | 15 | 16 |
| Power On | 1 | 1 | 0 | 0 | 1 | 1 | 1 | 0 | 1 | 1 | 1 | 1 | 1 | 1 | 1 | 1 |

In some implementations, not every zone is swept in every iteration. In such an implementation, the sweep pattern can be carried out over multiple iterations, for example as (where 1 indicates that the zone is swept and 0 indicates that the zone is not swept (e.g., power off)):

| | Zone 1 | Zone 2 | Zone 3 | Zone 4 |
|---|---|---|---|---|
| Iteration 1 | 1 | 1 | 1 | 1 |
| Iteration 2 | 1 | 1 | 1 | 1 |
| Iteration 3 | 0 | 1 | 1 | 1 |
| Iteration 4 | 0 | 0 | 1 | 1 |

As described herein, in some implementations, a beamsweeping pattern can be determined using weighting groups, with each weighting group assigned a particular weight or weighting formula for the zones without the weighting group. Various minimum and/or maximum allotment thresholds can be assigned within each weighting group, and can vary based on the number of zones within each weighting group. Thus, beamsweeping pattern determination can involve a complex algorithm with many parameters that can be optimized. It can be significant to optimize the rules, the applicable weights, the thresholds, etc. In some implementations, the number of weighting groups can be optimized by adding or removing weighting groups. Optimizing weights, movement rules, etc., can be complex as there are multiple parameters that can be adjusted, and optimized parameter values can change over time, for example based on changes in user behavior, changes in desired results (e.g., minimizing attachment times, minimizing power usage, or some combination of reducing attachment times and power usage).

In some implementations, a machine learning model is trained to optimize one or more parameters based on a desired outcome. For example, a machine learning model can be trained using historical attachment data to minimize average attachment time, maximize power savings, etc. In some implementations, limitations can be placed on the machine learning model's outputs. For example, if a machine learning model determines that zone four should never be swept, a floor limitation can set the sweep frequency for zone four to a minimum floor amount, such that zone four is still swept at least from time to time.

In some implementation, a machine learning model can use linear regression, polynomial regression, gradient descent, genetic algorithm, Bayesian optimization algorithm, neural network, support vector machine, etc. Depending upon the parameters to be adjusted (e.g., movement rule values, weights, etc.), different algorithms can be used. For example, linear or polynomial regressions may be more appropriate for relatively simple relationships between input parameters and the output, while more complex approaches such as neural networks can be used for highly non-linear or complex relationships.

Optimizing parameters for an algorithm as described above can be desirable because the outputs can be used to specify a highly deterministic, highly explainable algorithm for determining which weighting group a zone should be in and what the weights for zones within each weighting group should be.

In some implementations, rather than optimizing parameters of a pre-defined algorithm using a machine learning algorithm, a machine learning algorithm can be used directly to determine beamsweeping patterns. For example, a machine learning algorithm can be trained to optimize one or more parameters such as attachment time and/or power usage by training the model on historical data that includes attachment information such as attachment zone, attachment time, etc.

In some implementations, beamsweeping configurations are based on, for example, an average or weighted average of past attachments, without the use of weighting zones. In some implementations, past attachments are weighted such that more recent attachments have greater influence on the beamsweeping pattern. For example, the portion of time dedicated to each zone can be proportional to how often each zone has been used for attachment. Using a weighted, time-decaying average can be advantageous as the resulting allotments can be more strongly reflective of current attachment patterns. The particular decay used can vary, with slower decays resulting in more stable allotments and faster decays resulting in more rapid changes to allotments. The decay rate can be optimized for different base stations. For example, some base stations may have relatively stable attachment patterns over long periods of time, while other base stations may experience more frequent, substantial changes in attachment patterns, which may warrant a faster decay.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

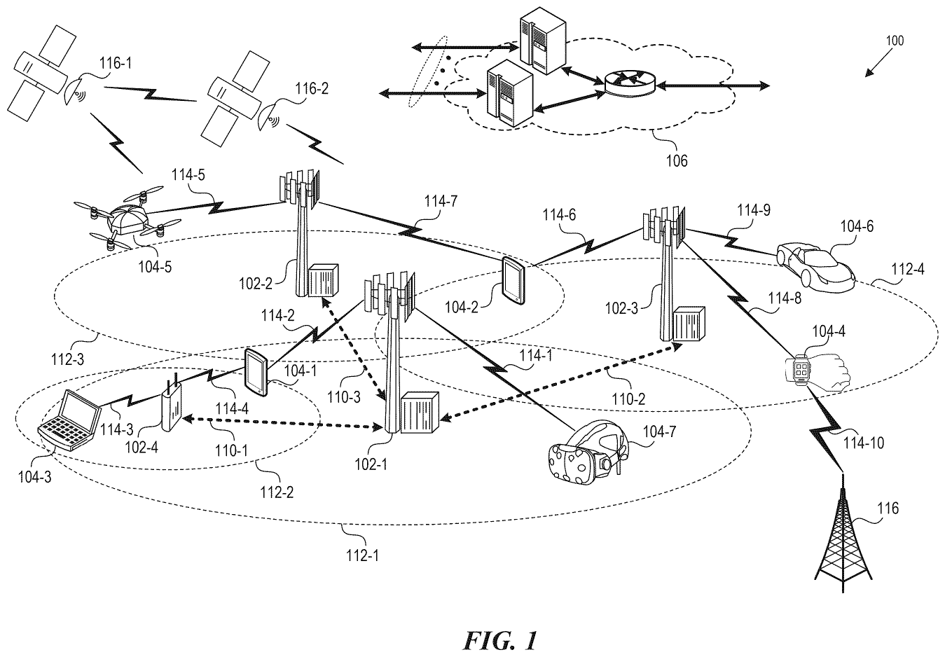

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

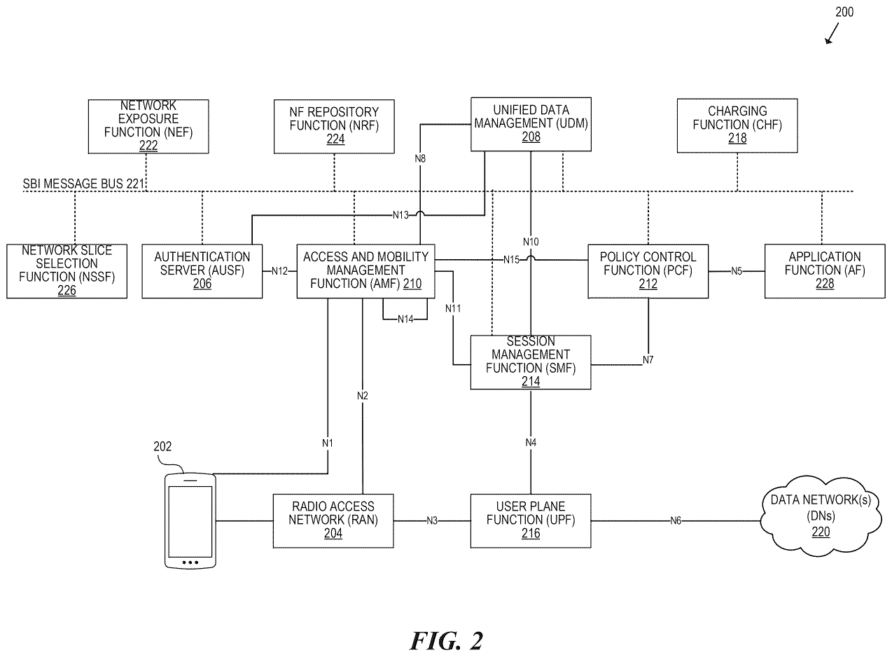

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNS) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Example Implementations

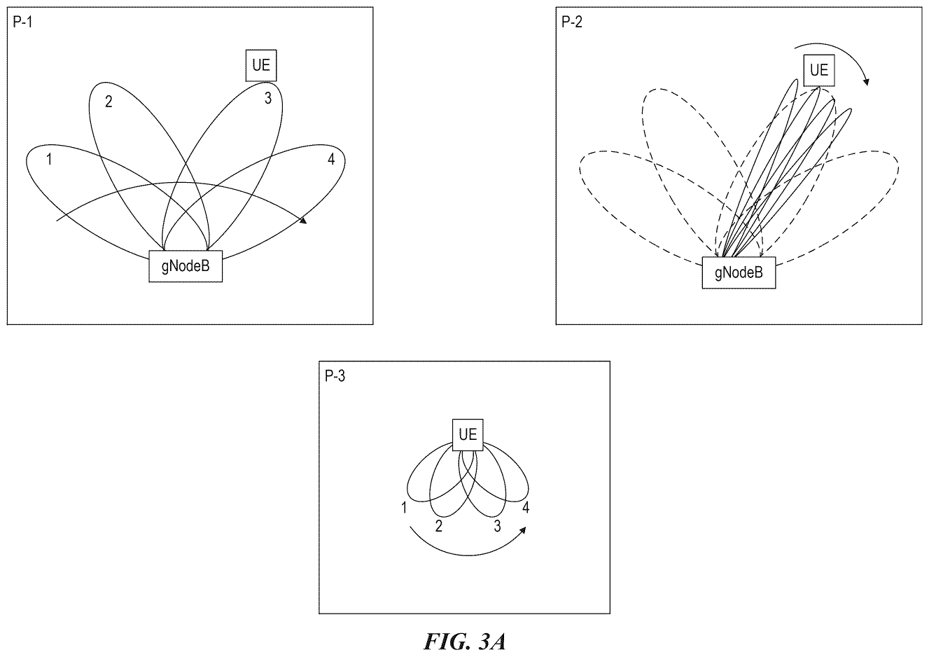

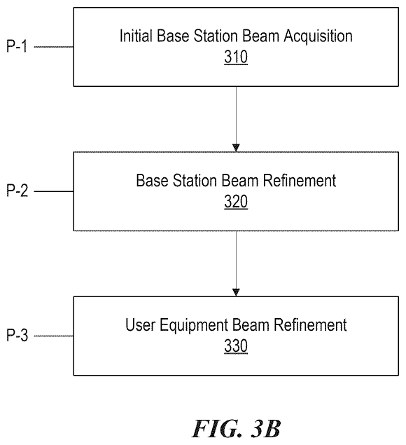

FIG. 3A is a drawing that schematically illustrates an attachment and beam refinement process according to some implementations. In procedure P-1, a base station (e.g., gNodeB) sweeps multiple zones using relatively wide beams (e.g., SSB beams). In FIG. 3A, four zones are illustrated, but it will be appreciated that there can be more or fewer zones. As shown in FIG. 3A, a UE is located generally in the direction of beam three. In procedure P-2, the beam transmitted by the base station can be further refined within zone 3. In procedure P-3, the UE can perform its own beamsweeping to optimize its connection with the base station. In conventional approaches, the base station sweeps equally across all zones in P-1 and P-2. However, as described herein, such an approach can be inefficient. Efficiency (e.g., in terms of attachment speed and/or power consumption) can be improved using the approaches described herein.

FIG. 3B is a flowchart that illustrates an attachment and refinement process according to some implementations. At operation 310, a base station can sweep through different zones for initial beam acquisitions. At operation 320, the base station can refine the beam, for example by identifying a smaller zone within a larger zone that was identified at operation 310. At operation 330, a device such as a smartphone can perform beam refinement to align its own transmission toward the base station. As described herein, initial beam acquisition can use SSB, CSI-RS, or both. Refinement by the base station can be performed using CSI-RS beams.

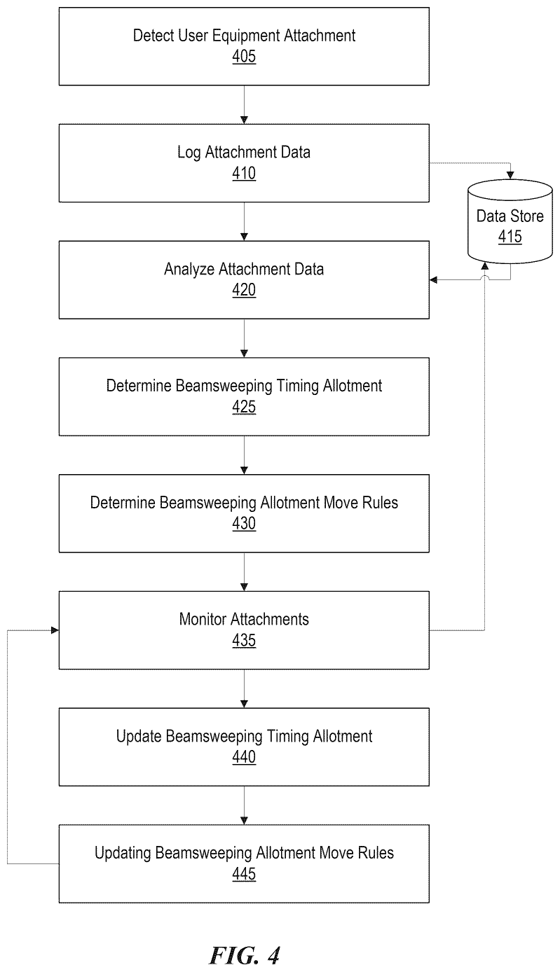

FIG. 4 is a flowchart that illustrates an example beamsweeping optimization process according to some implementations. At operation 405, a system can detect user equipment attachments. At operation 410, the system can log the attachment data in a data store 415. At operation 420, the system can analyze the attachment data in the data store 415. At operation 425, the system can determine a beamsweeping timing allotment. The timing allotment can indicate a relative proportion of time to sweep each zone or can indicate a portion of time that transmission is enabled in each zone. For example, a base station can be configured to continuously beamsweep but to dedicate more time to sweeping certain zones (e.g., zones with more frequent attachments) or to conserve power by only transmitting part of the time in certain zones and not transmitting in another part of the time. At operation 430, the system can determine beamsweeping allotment move rules. The beamsweeping allotment move rules can specify, for example, a number of attachments needed before a zone is moved up (thus having relatively greater beamsweeping time) or down (thus having relatively lesser beamsweeping time). At operation 435, the system can monitor subsequent attachments. At operation 440, the system can update the beamsweeping time allotment in response to the subsequent attachments. At operation 445, the system can update the beamsweeping allotment move rules in response to the subsequent attachments.

Using the process illustrated in FIG. 4, a system can update a beamsweeping optimization model over time, which can improve performance, for example by decreasing attachment times, conserving more power, or both.

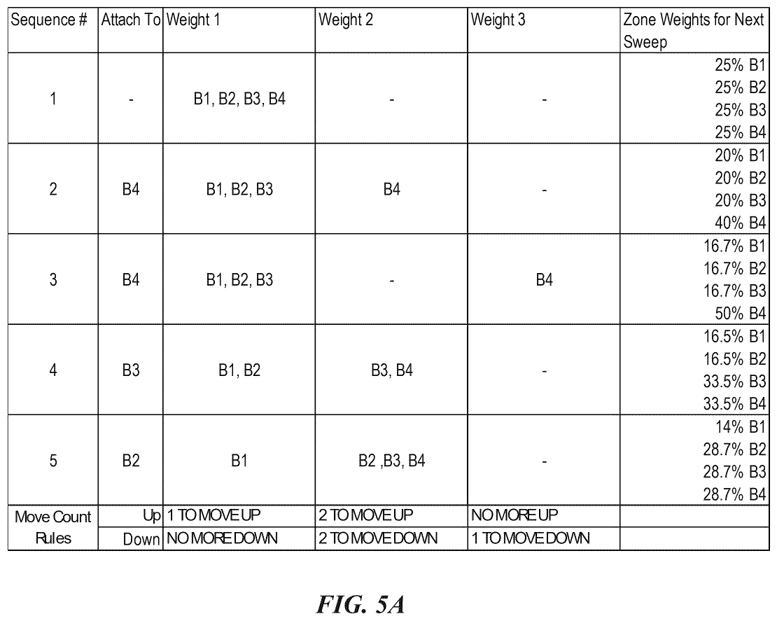

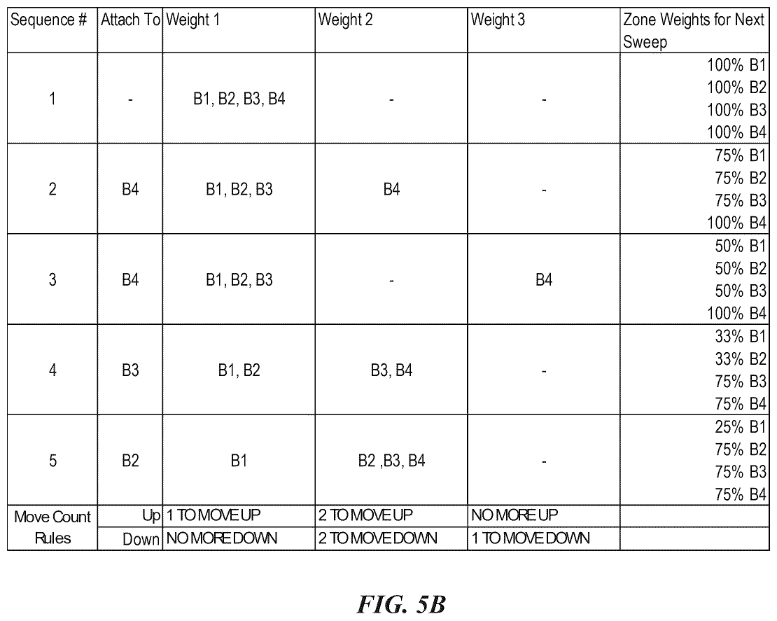

FIG. 5A is a table that illustrates an example historically-aware beamsweeping configuration according to some implementations. In FIG. 5A two kinds of parameters, move counts and frequency weights, control how subsequent beamsweeping operations are performed. Each row in FIG. 5A represents an attachment. In Sequence 1, before any attachment, each beam (B1, B2, B3, B4) is assigned weighting group 1. In a next sweep, each beam is swept 25% of the time (e.g., beamsweeping is dividing equally among zones 1-4). In Sequence 2, a UE attaches in the B4 zone, causing B4 to move from Weight 1 to Weight 2. In the example of FIG. 5A, B4 then has a 40% weight and B1-B3 have 20% weight each for the next attachment. In Sequence 3, another UE attaches in the B4 zone, causing B4 to move from weighting group 2 to weighting group 3. In the sweeps for the next attachment, zone B4 is given 50% weight while zones B1-B3 divide the other 50% equally. In Sequence 4, a UE attaches within the B3 zone. This causes B3 to move up from weighting group 1 to weighting group 2 and, in the example of FIG. 5A, causes B4 to move from weighting group 3 to weighting group 2, leaving B1 and B2 in weighting group 1 and B3 and B5 in weighting group 2. B3 and B4 split two thirds of the beamsweeping time equally, while B1 and B3 split the remaining ⅓ equally. In Sequence 5, a UE attaches in the B2 zone, causing B2 to move up from weighting group 1 to weighting group 2. No zones move down, as within weighting group 2, move count rules require two sequential attachments to move up or two sequential attachments to a different zone (or different zones) to move down.

In FIG. 5A, the base station sweeps continuously. That is, the base station does not stop transmitting when in certain zones or does not skip certain zones. Rather, the relative amount of time spent sweeping each zone changes over time. FIG. 5B is a table that illustrates an example historically-aware beamsweeping configuration according to some implementations. In FIG. 5B, the beamsweeping configuration reduces power consumption of the base station. The zone weights shown in FIG. 5B can indicate a portion of power on time in each zone during a sweep. In Sequence 1, which can be an initial state, all zones are swept without any power off period when a base station is not transmitting. In Sequence 2, a device attaches in zone B4. For the next sweep, the base station transmits throughout the entire time it would ordinarily be sweeping zone B4, but powers off for 25% of the time it would otherwise be sweeping each of zones B1, B2, and B3. Subsequent attachments move zones into different weighting groups, and the power on times are adjusted accordingly.

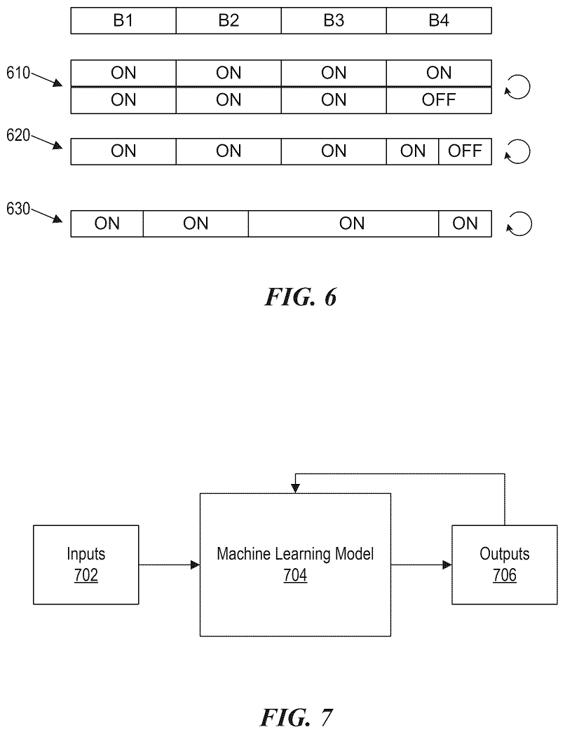

FIG. 6 is a drawing that schematically illustrates possible beamsweeping configurations according to some implementations. In FIG. 6, there are four zones B1-B4. Three beamsweeping configurations 610, 620, and 630 are illustrated. In beamsweeping configurations 620 and 630, a base station conserves power by limiting transmission within one zone (B4). This can be a zone with relatively infrequent attachments or attachments further in the past than the other zones. In beamsweeping configuration 610, in a first sweep, all zones (B1-B4) are swept, and in a second pass, only zones B1-B3 are swept and the base station does not transmit into zone B4. This two-pass beamsweeping configuration can be repeated. When there is another UE attachment, the beamsweeping configuration can be updated depending upon which zone the UE attaches in. In beamsweeping configuration 620, only a single pass is used, with the same net power on time in zone B4 as that shown in beamsweeping configuration 610. That is, zones B1-B4 are swept for a full time interval, while the base station sweeps zone B4 for only half the time interval and does not transmit for the other half of the time interval. Beamsweeping configuration 630 illustrates a beamsweeping configuration that prioritizes reducing attachment time over power savings. In three beamsweeping configuration 630, the base station transmits for the entire sweep period, but allocates time differently for different zones. In the example of FIG. 6 and three beamsweeping configuration 630, the base station spends the least time sweeping zone B4, followed by zone B3. Zone B3 is allotted the most time during the sweep period. This can be because recent attachments have been in B3 and few or no attachments have been seen recently in zone B4.

FIG. 7 illustrates a machine learning process according to some embodiments. As described herein, a machine learning model can be used to determine various parameters for a beamsweeping algorithm, such as move count rules, number of weighting groups, weights for each weighting group, minimum weighting thresholds, maximum weighting thresholds, and so forth. A machine learning model 704 can receive inputs 702 and produce outputs 706. The inputs can be, for example, historical attachment data. The historical attachment data can include, for example, attachment zones for historical attachments, attachment times for historical attachments, and so forth. In some implementations, the historical attachment data includes time information. As described herein, in some implementations, an attachment configuration algorithm includes time as a component of movement rules, for example so that more recent attachments have a greater impact than attachments longer in the past. The outputs 706 can include one or more parameters for the beamsweeping configuration algorithm, such as thresholds, movement rules, weighting thresholds, weights, and so forth. In some implementations, the outputs are fed back into the machine learning model 704 and used to update the model, which can result in improved outputs over time.

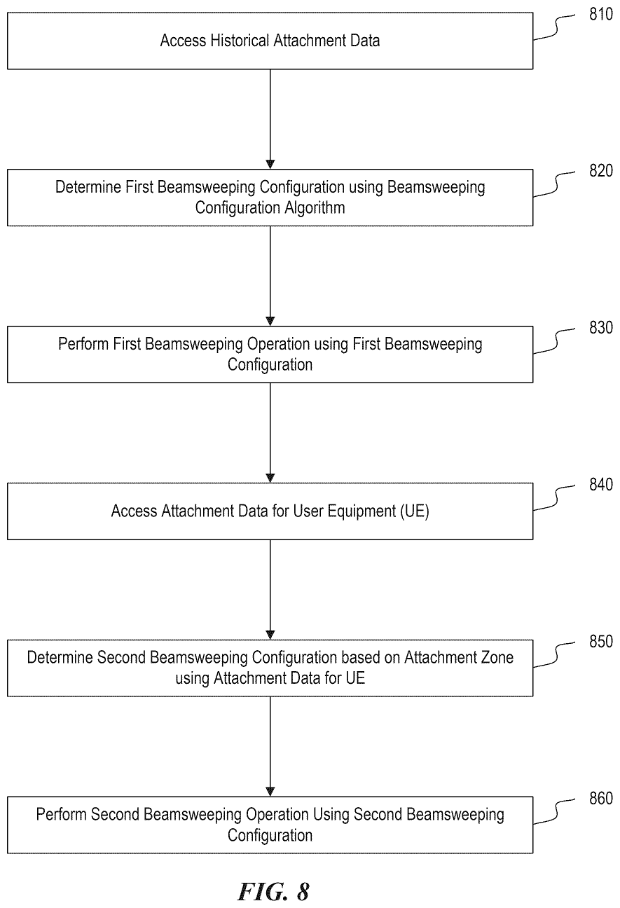

FIG. 8 is a flowchart of an example method for historically-aware beamsweeping according to some implementations. At operation 810, a system can access historical attachment data indicating a plurality of historical user equipment (UE) attachments. At operation 820, the system can determine, based on the historical attachment data using a beamsweeping configuration algorithm, a first beamsweeping configuration. At operation 830, the system can cause a base station to perform a first beamsweeping operation using the first beamsweeping configuration. At operation 840, the system can access attachment data for an attachment of a UE, wherein the attachment data indicates an attachment zone of the plurality of zones. At operation 850, the system can input the attachment zone to the beamsweeping configuration algorithm to determine a second beamsweeping configuration. At operation 860, the system can the base station to perform a second beamsweeping operation using the second beamsweeping configuration]. In some implementations, the system is different from the base station (e.g., operations can be performed by an external server or other system). In some implementation, the system is the base station. That is, the operations of FIG. 8 are carried out on the base station itself rather than an external system.

### Computer System

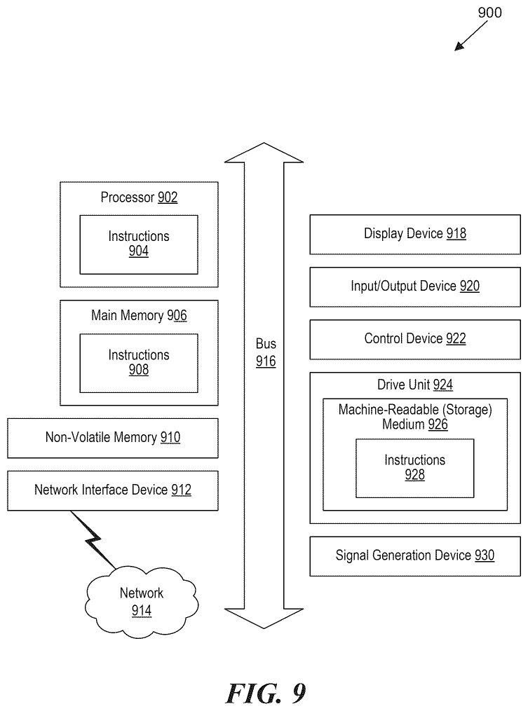

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a video display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computing system 900 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 900. In some implementations, the computer system 900 can be an embedded computer system, a system-on-chip (SOC), a single-board computer system (SBC), or a distributed system such as a mesh of computer systems, or it can include one or more cloud components in one or more networks. Where appropriate, one or more computer systems 900 can perform operations in real time, in near real time, or in batch mode.

The network interface device 912 enables the computing system 900 to mediate data in a network 914 with an entity that is external to the computing system 900 through any communication protocol supported by the computing system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computing system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computing system 900 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A method for historically aware beamsweeping by a base station of a wireless telecommunications network, the method comprising:
accessing historical attachment data indicating a plurality of historical user equipment (UE) attachments;
determining, based on the historical attachment data using a beamsweeping configuration algorithm, a first beamsweeping configuration,
wherein the first beamsweeping configuration identifies a plurality of parameters,
wherein each parameter of the plurality of parameters indicates a sweep parameter for a zone of a plurality of zones,
wherein each zone of the plurality of zones corresponds to an angular range of a geographic area associated with the base station,
wherein the beamsweeping configuration algorithm is configured to assign each zone of the plurality of zones to a weighting group of a plurality of weighting groups, wherein the plurality of weighting groups is used to determine a beamsweeping allotment value of one or more zones within each weighting group of the plurality of weighting groups, and
wherein the beamsweeping configuration algorithm is configured to assign a zone of the plurality of zones to a weighting group of the plurality of weighting groups based on one or more movement rules, wherein the movement rules are based on historical UE attachments;
causing the base station to perform a first beamsweeping operation using the first beamsweeping configuration;
accessing attachment data for an attachment of a UE,
wherein the attachment data indicates an attachment zone of the plurality of zones;
inputting the attachment zone to the beamsweeping configuration algorithm to determine a second beamsweeping configuration; and
causing the base station to perform a second beamsweeping operation using the second beamsweeping configuration.

2. The method of claim 1, further comprising:
accessing second attachment data for a second attachment of a second UE, wherein the second attachment data indicates a second attachment zone of the plurality of zones;
inputting the second attachment zone to the beamsweeping configuration algorithm to determine a third beamsweeping operation; and
causing the base station to perform a third beamsweeping operation using the third beamsweeping configuration.

3. A method for historically aware beamsweeping by a base station of a wireless telecommunications network, the method comprising:
accessing historical attachment data indicating a plurality of historical user equipment (UE) attachments;
determining, based on the historical attachment data using a beamsweeping configuration algorithm, a first beamsweeping configuration,
wherein the first beamsweeping configuration identifies a plurality of parameters,
wherein each parameter of the plurality of parameters indicates a sweep parameter for a zone of a plurality of zones,
wherein each zone of the plurality of zones corresponds to an angular range of a geographic area associated with the base station;
causing the base station to perform a first beamsweeping operation using the first beamsweeping configuration;
accessing attachment data for an attachment of a UE,
wherein the attachment data indicates an attachment zone of the plurality of zones;
inputting the attachment zone to the beamsweeping configuration algorithm to determine a second beamsweeping configuration; and
causing the base station to perform a second beamsweeping operation using the second beamsweeping configuration.

4. The method of claim 3, further comprising:
accessing second attachment data for a second attachment of a second UE, wherein the second attachment data indicates a second attachment zone of the plurality of zones;
inputting the second attachment zone to the beamsweeping configuration algorithm to determine a third beamsweeping operation; and
causing the base station to perform a third beamsweeping operation using the third beamsweeping configuration.

5. The method of claim 4, wherein the second UE is different from the UE.

6. The method of claim 3, wherein the beamsweeping configuration algorithm is configured to assign each zone of the plurality of zones to a weighting group of a plurality of weighting groups, wherein the plurality of weighting groups is used to determine a beamsweeping allotment value of one or more zones within each weighting group of the plurality of weighting groups.

7. The method of claim 6, wherein a zone of the plurality of zones is assigned to a weighting group of the plurality of weighting groups based on one or more movement rules, wherein the movement rules are based on historical UE attachments.

8. The method of claim 6, wherein the beamsweeping allotment value is used to determine a portion of a total sweep time that is allotted to a zone.

9. The method of claim 6, wherein the beamsweeping allotment value is used to determine a power off time, the power off time indicating an amount of time that the base station does not transmit in a zone.

10. The method of claim 6, wherein the beamsweeping allotment value is determined based at least in part on a number of zones included in a weighting group.

11. The method of claim 3, wherein the base station is a 5G base station, and wherein the attachment includes transmitting a synchronization signal block (SSB) beam in each zone of the plurality of zone and selecting a zone of the plurality of zones based on at least one of received signal strength or reference signal received power.

12. A system comprising:
at least one hardware processor; and
at least one non-transitory memory storing instructions, which, when executed by the at least one hardware processor, cause the system to:
access historical attachment data indicating a plurality of historical user equipment (UE) attachments to a base station of a wireless telecommunications network;
determine, based on the historical attachment data using a beamsweeping configuration algorithm, a first beamsweeping configuration,
wherein the first beamsweeping configuration identifies a plurality of parameters,
wherein each parameter of the plurality of parameters indicates a sweep parameter for a zone of a plurality of zones,
wherein each zone of the plurality of zones corresponds to an angular range of a geographic area associated with the base station;
cause the base station to perform a first beamsweeping operation using the first beamsweeping configuration;
access attachment data for an attachment of a UE,
wherein the attachment data indicates an attachment zone of the plurality of zones;
input the attachment zone to the beamsweeping configuration algorithm to determine a second beamsweeping configuration; and
cause the base station to perform a second beamsweeping operation using the second beamsweeping configuration.

13. The system of claim 12, wherein the instructions are further configured to cause the system to:
access second attachment data for a second attachment of a second UE, wherein the second attachment data indicates a second attachment zone of the plurality of zones;
input the second attachment zone to the beamsweeping configuration algorithm to determine a third beamsweeping operation; and
cause the base station to perform a third beamsweeping operation using the third beamsweeping configuration.

14. The system of claim 12, wherein the beamsweeping configuration algorithm is configured to assign each zone of the plurality of zones to a weighting group of a plurality of weighting groups, wherein the plurality of weighting groups is used to determine a beamsweeping allotment value of one or more zones within each weighting group of the plurality of weighting groups.

15. The system of claim 14, wherein a zone of the plurality of zones is assigned to a weighting group of the plurality of weighting groups based on one or more movement rules, wherein the movement rules are based on historical UE attachments.

16. The system of claim 14, wherein the beamsweeping allotment value is used to determine a portion of a total sweep time that is allotted to a zone.

17. The system of claim 14, wherein the beamsweeping allotment value is used to determine a power off time, the power off time indicating an amount of time that the base station does not transmit in a zone.

18. The system of claim 14, wherein the beamsweeping allotment value is determined based at least in part on a number of zones included in a weighting group.

19. The system of claim 12, wherein the base station is a 5G base station, and wherein the attachment includes transmitting a synchronization signal block (SSB) beam in each zone of the plurality of zone and selecting a zone of the plurality of zones based on at least one of received signal strength or reference signal received power.

20. The system of claim 12, wherein the system and the base station are a same system.
